(19) United States
(12) Patent Application Publication
(10) Pub. No.: US 2011/0187656 A1
(43) Pub. Date: Aug. 4, 2011

(54) INTERFACE APPARATUS AND METHOD

(75) Inventors: Byoung Tae KIM, Seoul (KR); Youngkyoung KIM, Seoul (KR); Dek Hwan NO, Goyang-si (KR); Sunyoung PARK, Jeju-si (KR); Jung Ah YANG, Seoul (KR); Jeonghwa YOO, Anyang-si (KR); Yeon Moon LEE, Goyang-si (KR); Yong Beom LEE, Seoul (KR); Yong Joo LEE, Anyang-si (KR); Chunghoon LEE, Seoul (KR); Hee Dong JANG, Seoul (KR)

(73) Assignee: PANTECH CO., LTD., Seoul (KR)

(21) Appl. No.: 12/908,704

(22) Filed: Oct. 20, 2010

(30) Foreign Application Priority Data
Feb. 2, 2010 (KR) 10-2010-0009535

(51) Int. Cl. G08B 6/00

(52) U.S. Cl. 345/173

(57) ABSTRACT

An interface apparatus and method that may display an interface image by synthesizing a reference resonance frequency with the interface image, and may transmit a resonance occurrence frequency to the displayed interface image to generate a resonance between the reference resonance frequency and the resonance occurrence frequency to provide a user with sensory feedback.

### CROSS-REFERENCE TO RELATED APPLICATION

This application claims priority from and the benefit of Korean Patent Application No. 10-2010-0009535, filed on Feb. 2, 2010, which is hereby incorporated by reference for all purposes as if fully set forth herein.

### BACKGROUND

1. Field

Exemplary Embodiments of the Present Invention Relate to an Interface Apparatus and method, and more particularly, to an interface apparatus and method that may produce sensory feedback.

2. Discussion of the Background

A medium permits communication between human beings and media represented is by an image or a voice. The medium may be defined by the term “interface”. With development of technology, the interface has been developed to depend on senses of human beings. Technology depending on only visual sensation and auditory sensation is available and technology using olfactory sensation, gustatory sensation, tactile sensation, and the like is gradually being developed.

In the case of a touch interface having a Man Machine Interface (MMI), mobile terminal technology may use a vibration and haptic interface by adding an audiovisual interface and a tactile interface.

However, in the case of a hologram or a virtual display apparatus, an interface image is output to an object, for example, a desk using wood, a wire, or plastic as a medium, or in the air where air is used as a medium. Accordingly, the audiovisual interface may be provided whereas the tactile interface may not be provided.

### SUMMARY

Exemplary embodiments of the present invention provide an interface apparatus and method that may produce sensory feedback with respect to a user input.

Exemplary embodiments of the present invention also provide an interface apparatus and method that may produce sensory feedback so that a user may feel a reaction corresponding to a user input via a sense.

Exemplary embodiments of the present invention also provide an interface apparatus and method that may produce sensory feedback using a resonance of a frequency so that a user may feel a reaction corresponding to a user input via a sense.

Additional features of the invention will be set forth in the description which is follows, and in part will be apparent from the description, or may be learned by practice of the invention.

An exemplary embodiment of the present invention discloses an interface apparatus including a resonance frequency generator to generate a reference resonance frequency and a resonance occurrence frequency, a display unit to display an interface image by synthesizing the reference resonance frequency with the interface image, a touch sensor to sense a touch on the displayed interface image, and a resonance generator to generate a resonance between the resonance occurrence frequency and the reference resonance frequency synthesized with the displayed interface image by outputting the resonance occurrence frequency to the displayed interface image.

An exemplary embodiment of the present invention also discloses an interface apparatus including a resonance frequency generator to generate a plurality of reference resonance frequencies and a plurality of resonance occurrence frequencies respectively corresponding to the plurality of reference resonance frequencies, a display unit to display an interface image by dividing the interface image into reference areas, and by synthesizing one of the reference resonance frequencies with one of the divided areas, a touch sensor to sense a touch of at least one of the divided areas of the displayed interface image, and a resonance generator to generate a resonance with the synthesized reference resonance frequency by outputting, to the at least one divided area in which the touch is sensed, a resonance occurrence frequency corresponding to the synthesized reference resonance frequency.

An exemplary embodiment of the present invention also discloses a method for providing an interface, the method including generating a reference resonance frequency and a resonance occurrence frequency, synthesizing the reference resonance frequency with the is interface image, displaying the interface image, sensing a touch of the displayed interface image, and generating a resonance between the resonance occurrence frequency and the reference resonance frequency synthesized with the displayed interface image by outputting the resonance occurrence frequency to the displayed interface image.

An exemplary embodiment of the present invention also discloses a method for providing an interface, the method including generating a plurality of reference resonance frequencies and a plurality of resonance occurrence frequencies respectively corresponding to the plurality of reference resonance frequencies, dividing an input interface image into reference areas, synthesizing one of the reference resonance frequencies with one of the reference areas, displaying the interface image, sensing a touch of at least one of the reference areas of the displayed interface image, and generating a resonance with the synthesized reference resonance frequency by outputting, to the at least one reference area in which the touch is sensed, a resonance occurrence frequency corresponding to the synthesized reference resonance frequency.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an example of outputting an interface image by an interface apparatus according to an exemplary embodiment of the present invention.

FIG. 2 is a block diagram illustrating a configuration of an interface apparatus according to an exemplary embodiment of the present invention.

FIG. 3 is a block diagram illustrating a configuration of a display unit when an interface apparatus outputs a two-dimensional (2D) interface image in the air according to an exemplary embodiment of the present invention.

FIG. 4 is a diagram illustrating an example of an interface image output by an interface apparatus according to an exemplary embodiment of the present invention.

FIG. 5 is a flowchart illustrating a process of producing, by an interface apparatus, sensory feedback with respect to a user input according to an exemplary embodiment of the present invention.

FIG. 6 is a flowchart illustrating a process of producing, by an interface apparatus, different sensory feedback with respect to a user input for each input location according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may is be exaggerated for clarity. Like reference numerals in the drawings denote like elements.

It will be understood that when an element is referred to as being “connected to” another element, it can be directly connected to the other element, or intervening elements may be present.

According to exemplary embodiments of the present invention, there may be provided an interface apparatus and method that may produce sensory feedback using a resonance of a frequency so that a user may feel a reaction corresponding to a user input.

Sensation may be classified into a general sensation that may be received anywhere on a human body, and a special sensation that may be received only via a receptor existing in a particular portion of the human body. A special sensation may include an olfactory sensation, a visual sensation, an auditory sensation, a sensation of equilibrium, and a gustatory sensation. A special sensation may be transmitted to the brain via cranial nerves and not by the spinal cord. All the sensations being transmitted by the spinal cord via spinal nerves may correspond to general sensations.

A general sensation may be classified into mechanoception, thermoception, and nociception depending on a type of stimulus.

The mechanoception may also be classified into a wide definition of a tactile sensation to sense physical transformation of a human body, and a kinesthetic sensation. The wide definition of the tactile sensation may be classified into a narrow definition of a touch sensation, a pressure sensation, and a flutter-vibration sensation.

The narrow definition of touch sensation denotes a sensation that may be sensed by a receptor existing in a shallow portion of the human body, such as near external skin. The touch sensation may be classified either into a discriminative touch sensation that may clearly is identify a corresponding portion of the skin, dynamics, and texture, or into a rough or light touch sensation that may not be clearly identifiable; however, the corresponding portion, the dynamics, and the texture may be readily felt.

The pressure sensation denotes a sensation that may be sensed by a receptor existing in a deeper portion of the human body and may be sensed in a relatively wide range for a relatively long sensing period compared to the narrow definition of a touch sensation. The flutter-vibration sensation denotes a quick repetitive touch sensation. Here, a sensation responding to a low frequency of a repetitive touch sensation is referred to as flutter, and a sensation responding to a high frequency of a repetitive touch sensation is referred to as vibration.

A tactile reception sensing the wide definition of a tactile sensation may include, for example, Merkel's corpuscle, Ruffini's corpuscle, Meissner's corpuscle, Pacinian corpuscle, and the like.

Merkel's corpuscle may include Merkel cells that are particular epithelial cells existing in the epidermis of humans and expanded axona ending, that is, a Merkel's disk having a synapse in the Merkel cells. This receptor may sense the discriminative touch sensation, and may be a position detector to detect a transformation level of a portion of skin, and a slowly adapting receptor having a long refractory period with respect to a stimulus.

Ruffini's corpuscle may exist within the dermis of skin to receive the pressure sensation, and may be found in a spindle structure having a length of 0.5 mm to 2 mm where a plurality of diverged axons and ends of diverged axons are surrounded by connective epithelium. This receptor may also be a position detector and a slowly adapting receptor having a long refractory period with respect to a stimulus. Also, Merkel's corpuscle is referred to as a Type-1 is slowly adapting receptor, and Ruffini's corpuscle is referred to as a Type-2 slowly adapting receptor.

Meissner's corpuscle may exist in dermal papilla and be found in smooth skin, such as palms, soles, inside of fingers, lips, nipples, pudenda, and the like. Meissner's corpuscle may be a relatively large receptor surrounded by connective epithelium and have a length of 40 μm to 100 μm and width of 30 μm to 60 μm. With medullated nerves coming into pellicles, myelin sheaths may disappear and a twisted-and-winding up shape may appear. Schwann cells are arranged in the same direction as axons and thus Meissner's corpuscle may be easily identified even in general H-E chromosomes. Meissner's corpuscle may detect a dynamic state using a velocity detector detecting a velocity of transformation rather than a transformed state, and receive flutter using a rapidly adapting receptor having a short refractory period with respect to a stimulus.

Pacinian corpuscle may exist deep within the derma and subcutaneous tissues as a relatively large structure wrapped by connective epithelium and have a length of 1 mm to 4 mm and a width of 2 mm. Pacinian corpuscle may be found deep within the mucous membrane, mesentery, capsule of viscera such as the pancreas and the like, the heart, and corneas and conjunctiva of eyes. Thick medullated nerves are distributed in Pacinian corpuscle. Nerve fibers come from a lower portion of Pacinian corpuscle. When nerve fibers penetrate through capsule, myelin sheaths disappear and ends of nerves are upwardly extended to be straight. They are surrounded by Schwann cells transformed to be flat, and about 20 to 70 layers of concentric connective tissues surround nerve endings. Pacinian corpuscle may be a representative transient detector detecting an acceleration level of stimulus, and receive a vibration due to a short refractory period.

Each of receptors sensing tactile sensation may have a different frequency range sensing perception, and the frequency range may be expressed by the following Table 1:

TABLE 1

| Receptors | Frequency range | | Perception |
|---|---|---|---|
| Merkel | 0.3~3 | Hz | Pressure |
| Meissner | 3~40 | Hz | Flutter |
| Ruffini | 15~400 | Hz | Stretching |
| Pacinian | 10~500 | Hz | Vibration |

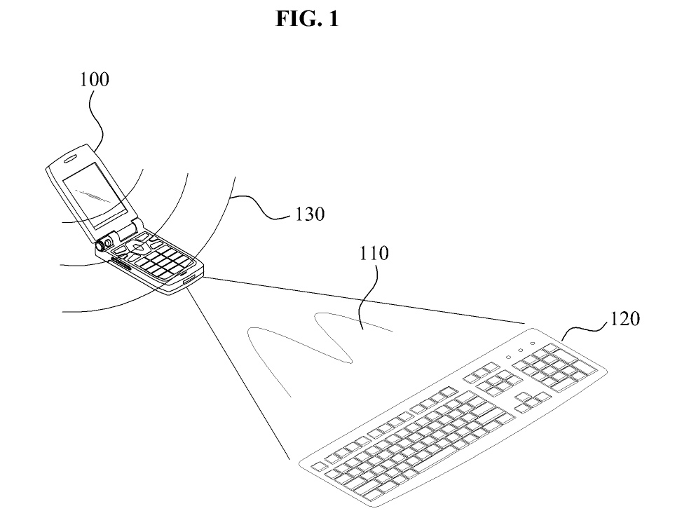

FIG. 1 is a diagram illustrating an example of outputting an interface image by an interface apparatus 100 according to an exemplary embodiment of the present invention. Referring to FIG. 1, the interface apparatus 100 may output an interface image 110 in which a reference resonance frequency is synthesized (hereinafter, with a synthesized reference resonance frequency) to thereby display the interface image on an object. If the interface apparatus 100 senses a touch on the displayed interface image 120, the interface apparatus 100 may generate a resonance by outputting, to the displayed interface image 120, a resonance occurrence frequency 130 that may generate a resonance having a magnitude sufficiently strong for a user to feel a tactile sensation if the resonance occurrence frequency 130 is combined with the reference resonance frequency. Specifically, if the user touches the displayed interface image 120, the tactile sensation may be fed back to the user through the resonance.

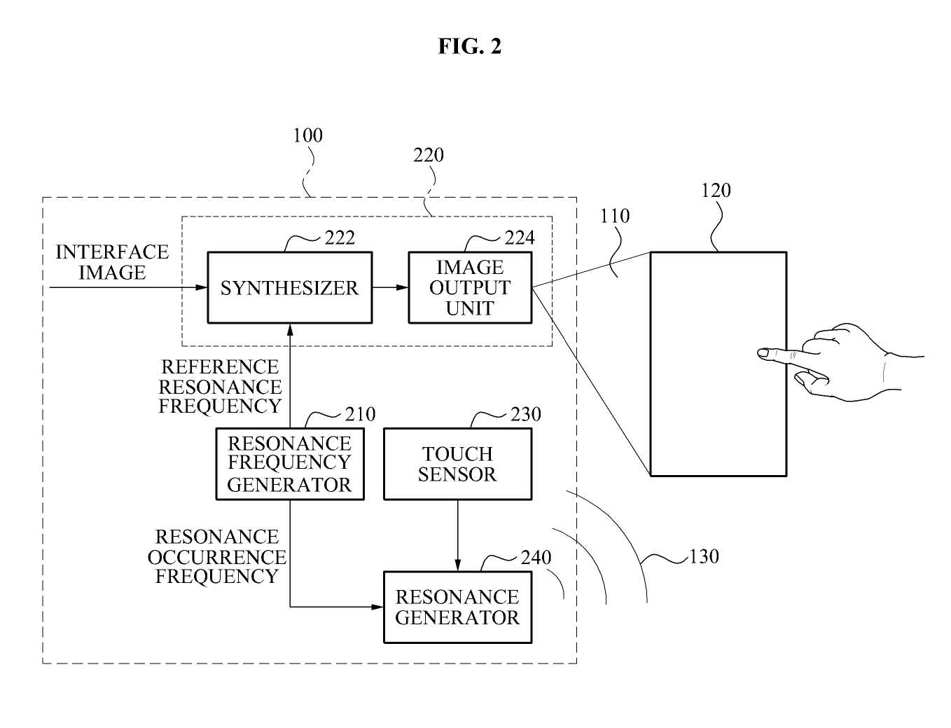

Hereinafter, a configuration of the interface apparatus 100 will be further described. FIG. 2 is a block diagram illustrating a configuration of the interface apparatus 100 according to an exemplary embodiment of the present invention. Referring to FIG. 2, the is interface apparatus 100 may include a resonance frequency generator 210, a display unit 220, a touch sensor 230, and a resonance generator 240.

The resonance frequency generator 210 may generate a reference resonance frequency and a resonance occurrence frequency. If the reference resonance frequency is combined with the resonance occurrence frequency, a resonance may be generated and sensed by the user. The resonance may correspond to a frequency having at least a reference magnitude. The frequency occurring due to the resonance may have a magnitude sufficiently large for the user to feel the tactile sensation.

The display unit 220 may display the interface image 110 by synthesizing the reference resonance frequency with the interface image. The display unit 220 may two-dimensionally display, on an object, the interface image 110 with the synthesized reference resonance frequency, or may two-dimensionally or three-dimensionally display the interface image 110 with the synthesized reference resonance frequency by using air as a medium. The display unit 220 that two-dimensionally displays the interface image 110 on the object may include a synthesizer 222 and an image output unit 224.

The synthesizer 222 may synthesize the reference resonance frequency with the interface image. The image output unit 224 may two-dimensionally display, on the object, the interface image 110 with the synthesized reference resonance frequency.

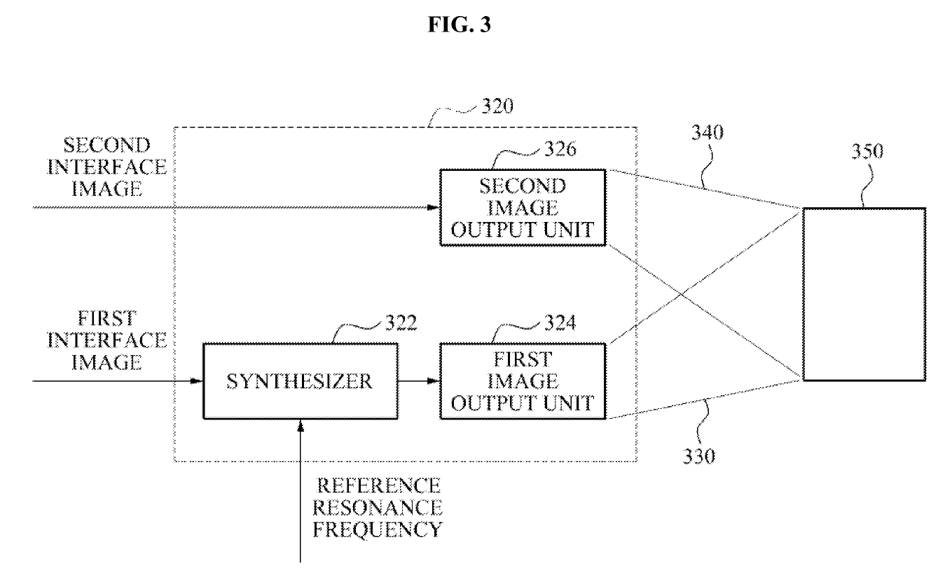

Hereinafter, a display unit 320 that two-dimensionally displays the interface image in the air will be described with reference to FIG. 3.

FIG. 3 is a block diagram illustrating a configuration of the display unit 320 when the interface apparatus 100 outputs a two-dimensional (2D) interface image in the air according to an exemplary embodiment of the present invention. Referring to FIG. 3, the display unit 320 is outputting the 2D interface image in the air by using air as a medium may include a synthesizer 322, a first image output unit 324, and a second image output unit 326.

The synthesizer 322 may synthesize the reference resonance frequency with a first interface image 330. The first image output unit 324 may output the first interface image 330 with the synthesized reference resonance frequency. The second image output unit 326 may output a second interface image 340 to display a 2D interface image 350 by generating frequency interference against the first interface image 330 with the synthesized reference resonance frequency and by using air as a medium.

Referring again to FIG. 2, the touch sensor 230 may sense a human being or an object around the displayed interface image 120, and sense a contact between the object or the human being and the displayed interface image 120. The touch sensor 230 may sense a motion of the human being or the object using an infrared sensor (not shown) or an image sensor (not shown) and thereby sense a touch on the displayed interface image 120. The infrared sensor may sense the motion of the object using a Time of Flight (TOF) method for finding a movement time of light by emitting infrared rays to the object and by sensing light reflected and returned from the object. The image sensor may sense the motion of the object by photographing an image and using the photographed image.

If the touch on the displayed interface image 120 is sensed, the resonance generator 240 may generate a resonance with the reference resonance frequency synthesized with the displayed interface image 120 by outputting the resonance occurrence frequency to the displayed interface image 120.

In this instance, the resonance may correspond to a frequency greater than at least a reference frequency and the frequency occurring due to the resonance may have a magnitude is sufficiently strong for a user to feel tactile sensation. The user may sense the resonance using a resonance sensor (not shown) provided, for example, in a glove shape, and may receive the sensed resonance as tactile sensation. The resonance sensor may sense the resonance having the frequency of the reference frequency, and provide the user with the sensed resonance as the tactile sensation. The resonance sensor may provide the tactile sensation through amplification of a resonance frequency using a frequency amplifier, or may provide the tactile sensation by transforming the sensed resonance to vibration using a vibrator.

The resonance generator 240 may cause trembling in the displayed interface image 120 through the resonance. The user may visually sense that the displayed interface image 120 is touched based on the trembling of the displayed interface image 120.

If the displayed interface image 120 is touched, the interface apparatus 100 may enable different tactile sensations to be felt depending on a touched area. Hereinafter, an operation of the resonance frequency generator 210, the display unit 220, the touch sensor 230, and the resonance generator 240 in the interface apparatus 100 generating the different tactile sensation depending on a touch area will be described.

The resonance frequency generator 210 may generate a plurality of reference resonance frequencies and a plurality of resonance occurrence frequencies corresponding to the plurality of reference resonance frequencies. Each of the reference resonance frequencies and the resonance occurrence frequencies corresponding to the plurality of reference resonance frequencies may generate different tactile sensations using different resonances.

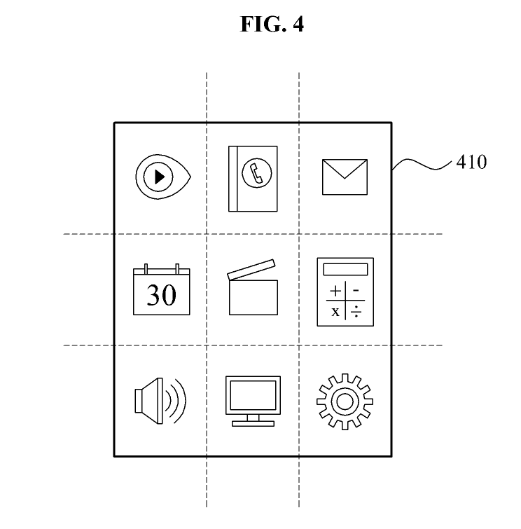

The display unit 220 may display an interface image by dividing the interface image into reference areas, and by synthesizing one of the reference resonance frequencies with each corresponding divided area. The interface image may be divided as shown in FIG. 4.

FIG. 4 is a diagram illustrating an example of an interface image 410 output by the interface apparatus 100 according to an exemplary embodiment of the present invention. Referring to FIG. 4, the display unit 220 may divide the interface image 410 into reference areas as indicated by dotted lines so that different tactile sensation may be felt for each icon, and may synthesize a different reference resonance frequency for each corresponding divided area.

The touch sensor 230 may sense a touch on at least one of the divided areas of the displayed interface image 410.

The resonance generator 240 may generate a resonance with the synthesized reference resonance frequency by outputting, to the at least one divided area in which the touch is sensed, a resonance occurrence frequency corresponding to the synthesized reference resonance frequency.

Hereinafter, an interface method of producing sensory feedback with respect to a user input according to an exemplary embodiment of the present invention will be described.

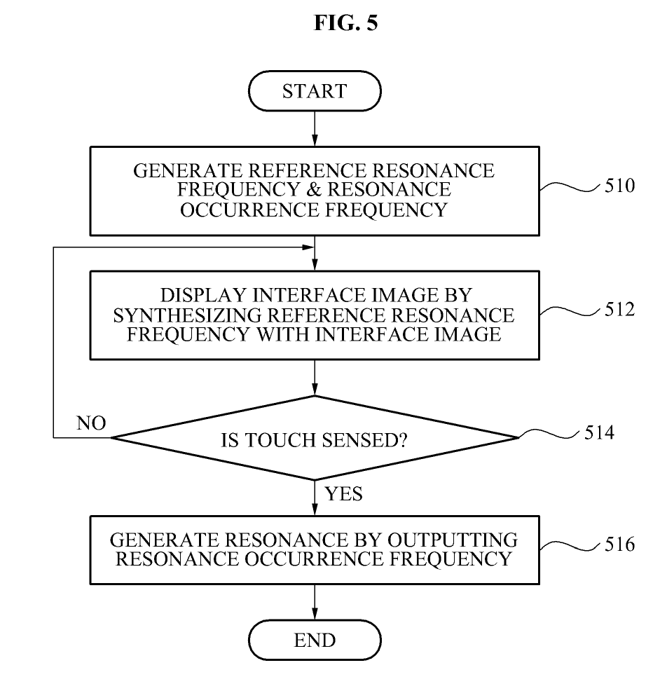

FIG. 5 is a flowchart illustrating a process of producing, by an interface apparatus, sensory feedback with respect to a user input according to an exemplary embodiment of the present invention.

Referring to FIG. 5, in operation 510, an interface apparatus may generate a reference resonance frequency and a resonance occurrence frequency. If the reference resonance frequency is combined with the resonance occurrence frequency, a resonance may be generated.

In operation 512, the interface apparatus may display an interface image by synthesizing the reference resonance frequency with the interface image. In this instance, the interface apparatus may two-dimensionally display, on an object, the interface image with the synthesized reference resonance frequency, or may two-dimensionally or three-dimensionally is display the interface image with the synthesized reference resonance frequency by using air as a medium.

In operation 514, the interface apparatus may sense a touch on the displayed interface image. If the touch on the displayed interface image is not sensed in operation 514, the interface apparatus may return to operation 512 and display the interface image with the synthesized reference resonance frequency.

If the touch is sensed in operation 514, the interface apparatus may generate a resonance between the resonance occurrence frequency and the reference resonance frequency synthesized with the displayed interface image by outputting the resonance occurrence frequency to the displayed interface image in operation 516. The resonance may have a magnitude sufficiently large to be sensed as a tactile sensation.

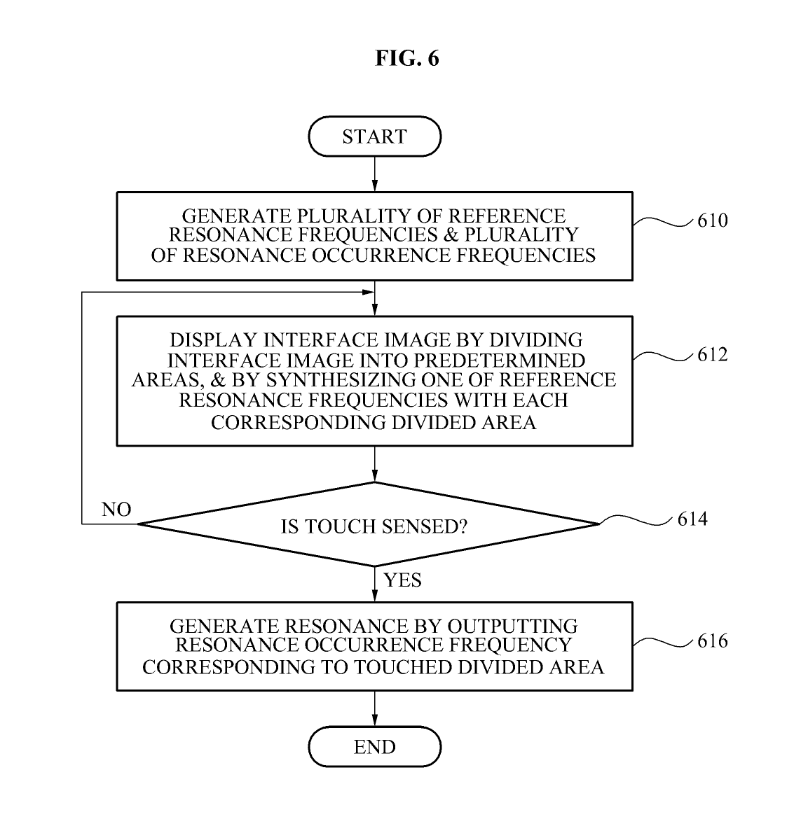

FIG. 6 is a flowchart illustrating a process of producing, by an interface apparatus, different sensory feedback with respect to a user input for each input location according to an exemplary embodiment of the present invention.

Referring to FIG. 6, in operation 610, the interface apparatus may generate a plurality of reference resonance frequencies and a plurality of resonance occurrence frequencies corresponding to the plurality of reference resonance frequencies. In this instance, if each of the reference resonance frequencies is combined with each corresponding resonance occurrence frequency, respectively, resonance may be generated, and each of the reference resonance frequencies and the resonance occurrence frequencies corresponding to the plurality of reference resonance frequencies may generate different tactile sensations in resonance.

In operation 612, the interface apparatus may display an interface image by dividing the interface image into reference areas, and by synthesizing one of the reference is resonance frequencies with each corresponding divided area. In this instance, the interface apparatus may two-dimensionally display, on an object, the interface image with the synthesized reference resonance frequency, or may two-dimensionally or three-dimensionally display the interface image with the synthesized reference resonance frequency by using air as a medium.

In operation 614, the interface apparatus may sense a touch on at least one of the divided areas of the displayed interface image. If the touch is not sensed in operation 614, the interface apparatus may return to operation 612 and display the interface image with the synthesized reference resonance frequencies.

If the touch is sensed in operation 614, the interface apparatus may generate a resonance with the synthesized reference resonance frequency by outputting, to the at least one divided area in which the touch is sensed, a resonance occurrence frequency corresponding to a reference resonance frequency synthesized with the touched divided area in operation 616.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their is equivalents.

What is claimed is:

1. An interface apparatus, comprising:
a resonance frequency generator to generate a reference resonance frequency and a resonance occurrence frequency;
a display unit to display an interface image by synthesizing the reference resonance frequency with the interface image;
a touch sensor to sense a touch on the displayed interface image; and
a resonance generator to generate a resonance between the resonance occurrence frequency and the reference resonance frequency synthesized with the displayed interface image by outputting the resonance occurrence frequency to the displayed interface image.

2. The interface apparatus of claim 1, wherein the resonance is generated in response to a touch of the displayed interface.

3. The interface apparatus of claim 1, wherein the resonance generated by the resonance generator is detectable by tactile sensation.

4. The interface apparatus of claim 1, wherein the display unit two-dimensionally displays, on an object, the interface image with the synthesized reference resonance frequency.

5. The interface apparatus of claim 1, wherein the display unit two-dimensionally or three-dimensionally displays the interface image with the synthesized reference resonance frequency by using air as a medium.

6. The interface apparatus of claim 1, wherein the display unit comprises:
a synthesizer to synthesize the reference resonance frequency with the interface image; and
an image output unit to two-dimensionally display, on an object, the interface image with the synthesized reference resonance frequency.

7. The interface apparatus of claim 1, wherein the display unit comprises:
a synthesizer to synthesize the reference resonance frequency with the interface image;
a first image output unit to output the interface image with the synthesized reference resonance frequency; and
a second image output unit to output an interference interface image to display a two-dimensional (2D) interface image by causing frequency interference with the interface image with the synthesized reference resonance frequency, and by using air as a medium.

8. The interface apparatus of claim 1, wherein the display unit comprises:
a synthesizer to synthesize the reference resonance frequency with the interface image;
a first image output unit to output the interface image with the synthesized reference resonance frequency; and
a second image output unit to output an interference interface image to display a three-dimensional (3D) interface image by causing frequency interference with the interface image with the synthesized reference resonance frequency, and by using air as a medium.

9. The interface apparatus of claim 1, wherein the touch sensor senses a motion of a human being or an object in an area within and around the displayed interface image.

10. An interface apparatus comprising:
a resonance frequency generator to generate a plurality of reference resonance frequencies and a plurality of resonance occurrence frequencies respectively corresponding to the plurality of reference resonance frequencies;
a display unit to display an interface image, by dividing the interface image into reference areas, and by synthesizing one of the reference resonance frequencies with one of the divided areas;
a touch sensor to sense a touch of at least one of the divided areas of the displayed interface image; and
a resonance generator to generate a resonance with the synthesized reference resonance frequency by outputting, to the at least one divided area in which the touch is sensed, a resonance occurrence frequency corresponding to the synthesized reference resonance frequency.

11. The interface apparatus of claim 10, wherein the resonance generated by the resonance generator is detectable by tactile sensation.

12. The interface apparatus of claim 10, wherein each of the reference resonance frequencies and the resonance occurrence frequencies corresponding to the plurality of reference resonance frequencies generates a different tactile sensation using different resonances.

13. The interface apparatus of claim 10, wherein the display unit two-dimensionally displays, on an object, the interface image with the synthesized reference resonance frequency.

14. The interface apparatus of claim 10, wherein the display unit two-dimensionally or three-dimensionally displays the interface image with the synthesized reference resonance frequency by using air as a medium.

15. The interface apparatus of claim 10, wherein the display unit comprises:
a synthesizer to divide the interface image into the reference areas, and to synthesize one of the reference resonance frequencies with one of the divided areas; and
an image output unit to two-dimensionally display, on an object, the interface image with the synthesized reference resonance frequencies.

16. The interface apparatus of claim 10, wherein the display unit comprises:
a synthesizer to divide the interface image into the reference areas, and to synthesize one of the reference resonance frequencies with one of the divided areas; and
a first image output unit to two-dimensionally output the interface image with the synthesized reference resonance frequencies; and
a second image output unit to output an interference interface image to display a two-dimensional (2D) interface image by causing frequency interference against the interface image with the synthesized reference resonance frequencies using air as a medium.

17. The interface apparatus of claim 10, wherein the display unit comprises:
a synthesizer to divide the interface image into the reference areas, and to synthesize one of the reference resonance frequencies with one of the divided areas; and
a first image output unit to three-dimensionally output the interface image with the synthesized reference resonance frequencies; and
a second image output unit to output an interference interface image to display a three-dimensional (3D) interface image by causing frequency interference against the interface image with the synthesized reference resonance frequencies and by using air as a medium.

18. The interface apparatus of claim 10, wherein the touch sensor senses a motion of a human being or an object in an area within and around the displayed interface image.

19. A method for providing an interface, the method comprising:
generating a reference resonance frequency and a resonance occurrence frequency;
synthesizing the reference resonance frequency with an input interface image;
displaying the interface image;
sensing a touch of the displayed interface image; and
generating a resonance between the resonance occurrence frequency and the reference resonance frequency synthesized with the displayed interface image by outputting the resonance occurrence frequency to the displayed interface image.

20. The method of claim 19, wherein the resonance is generated in response to a touch of the displayed interface image.

21. The method of claim 19, wherein the resonance generated by the resonance generator is detectable by tactile sensation.

22. The method of claim 19, wherein the displaying comprises two-dimensionally displaying, on an object, the interface image with the synthesized reference resonance frequency.

23. The method of claim 19, wherein the displaying comprises two-dimensionally or three-dimensionally displaying the interface image with the synthesized reference resonance frequency by using air as a medium.

24. The method of claim 19, wherein the displaying comprises:
outputting the interface image with the synthesized reference resonance frequency; and
outputting an interference interface image to generate a two-dimensional (2D) interface image by causing frequency interference against the interface image with the synthesized reference resonance frequency using air as a medium.

25. The method of claim 19, wherein the displaying comprises:
outputting the interface image with the synthesized reference resonance frequency; and
outputting an interference interface image to generate a three-dimensional (3D) interface image by causing frequency interference against the interface image with the synthesized reference resonance frequency using air as a medium.

26. The interface method of claim 19, wherein the sensing comprises sensing a motion of a human being or an object in an area within and around the displayed interface image.

27. A method for providing an interface, the method comprising:
generating a plurality of reference resonance frequencies and a plurality of resonance occurrence frequencies respectively corresponding to the plurality of reference resonance frequencies;
dividing an input interface image into reference areas;
synthesizing one of the reference resonance frequencies with one of the reference areas;
displaying the interface image;
sensing a touch of at least one of the reference areas of the displayed interface image; and
generating a resonance with the synthesized reference resonance frequency by outputting, to the at least one reference area in which the touch is sensed, a resonance occurrence frequency corresponding to the synthesized reference resonance frequency.

28. The method of claim 27, wherein the resonance generated by the resonance generator is detectable by tactile sensation.

29. The method of claim 27, wherein each of the reference resonance frequencies and the resonance occurrence frequencies corresponding to the plurality of reference resonance frequencies generates a different tactile sensation using different resonances.

30. The method of claim 27, wherein the displaying comprises two-dimensionally displaying, on an object, the interface image with the synthesized reference resonance frequency.

31. The method of claim 27, wherein the displaying comprises two-dimensionally or three-dimensionally displaying the interface image with the synthesized reference resonance frequency by using air as a medium.

32. The method of claim 27, wherein the displaying comprises:
outputting the interface image with the synthesized reference resonance frequencies; and
outputting an interference interface image to display a two-dimensional (2D) interface image by causing frequency interference with the interface image with the synthesized reference resonance frequencies using air as a medium.

33. The method of claim 27, wherein the displaying comprises:
outputting the interface image with the synthesized reference resonance frequencies; and
outputting an interference interface image to display a three-dimensional (3D) interface image by causing frequency interference with the interface image with the synthesized reference resonance frequencies using air as a medium.

34. The method of claim 27, wherein the sensing comprises sensing a motion of a human being or an object in an area within and around the displayed interface image.
